(19) United States
(12) Patent Application Publication
(10) Pub. No.: US 2023/0219461 A1
(43) Pub. Date: Jul. 13, 2023

(54) ELECTROCHEMICAL ENERGY STORAGE SYSTEM FOR HIGH-ENERGY AND HIGH-POWER REQUIREMENTS

(71) Applicant: Bia Power LLC, Menlo Park, CA (US)

(72) Inventor: Derek C. Johnson, Fort Collins, CO (US)

(73) Assignee: Bia Power LLC, Menlo Park, CA (US)

(21) Appl. No.: 18/117,279

(22) Filed: Mar. 3, 2023

Related U.S. Application Data
(63) Continuation of application No. PCT/US2021/050319, filed on Sep. 14, 2021.
(60) Provisional application No. 63/078,175, filed on Sep. 14, 2020.

(51) Int. Cl. B60L 58/22; H01M 10/625; H01M 10/44; B60L 7/10; B60L 58/24; B60L 50/60

(52) U.S. Cl. CPC B60L 58/22; H01M 10/625; H01M 10/441; B60L 7/10; B60L 58/24; B60L 50/66; H01M 2220/20

(57) ABSTRACT

An apparatus and method for electrochemical energy storage for high-power and high-energy autonomous applications, including autonomous electric vehicles having remote active drive cycle monitoring and/or governance and thermal management control, are described. For autonomous vehicles, the apparatus includes: at least one high-power, low-energy density tertiary storage battery having low cost, and designed to wear and be replaceable; at least one high energy density core battery; at least one intermediate power and energy density secondary battery for buffering the load on the core battery; and a battery controller. The autonomous vehicle energy requirement and consumption rate are provided in such a manner that performance degradation over the life of the system is reduced.

### CROSS-REFERENCE TO RELATED APPLICATIONS

The present application is a continuation of international application serial number PCT/US2021/050319, filed on 14 Sep. 2021 which claims the benefit of U.S. Provisional Patent Application No. 63/078,175 for “Electrochemical Energy Storage System For High-Energy And High-Power Requirements”, filed on 14 Sep. 2020, the entire contents of which applications are hereby specifically incorporated by reference herein for all that they disclose and teach.

### BACKGROUND

Electrification is accelerating in many industries as the need for a cleaner source of energy for both stationary and mobile applications is being driven by both environmental and governmental forces. Successful electrification, however, requires: (1) an increase in the performance of current state-of-the-art electrochemical energy storage devices; and (2) a reduction in the cost of these devices to ensure economic viability.

In dual drive-train electric vehicles both front and rear wheels are driven, which requires energy storage devices for vehicle propulsion as well as for other vehicle functions. In its simplest form, energy storage for these applications is achieved using a high-energy/low-power battery, which is generally nearly depleted during operation of the electric vehicle before being recharged. It is known that batteries meeting the energy needs of the vehicle cannot be recharged using high-power or high-energy electrical pulses from regenerative braking, as an example, since such pulses cause accelerated battery degradation. Rather, such batteries are more slowly recharged in order to reduce electrode degradation processes that occur during charging, and to meet end-of-life battery requirements.

The higher the capacity of the battery, the higher the absolute magnitude of the current pulse can be and still, by definition of the C-rate, result in a low charging rate when compared to the overall capacity of the battery. In order to ensure acceptable cycle life, power, DC resistance growth, end-of-life energy, and the required functional safety at the vehicle level, where the magnitude of the current pulse for a given application results in a low C-rate, such batteries must be overdesigned. These overdesign requirements often lead to devices that take up additional space and add extra cost when compared to a system that is optimally designed when only taking into consideration beginning-of-life requirements. In addition, such batteries also need significant temperature control to ensure performance, thereby resulting in low packing density, defined as the percentage of the battery used for components that store energy, such as a battery cell, and inherently have inefficient energy recovery. Conversely, if the battery is not overdesigned, that is, is designed for beginning-of-life requirements, there will be a performance gap at the end-of-life of the battery system leading to safety and other concerns.

More elaborate systems include two batteries: one configured to provide the energy requirement of an electric vehicle, and a second to provide the power requirement. Batteries capable of providing the power requirement can generally accept electrical pulses from regeneration devices in the vehicle, but do not have sufficient capacity to store the recovered energy. This leads to a conundrum of whether to design the battery that can accept energy from high-rate pulses, but does not have the capacity to store the recovered energy, or the needed energy for the application, or to design a battery that can store the energy, but does not have the capability to accept the energy at high rates.

As faster than expected innovation-to-adoption cycles become the rule in the on-demand transportation sector, autonomous vehicles (AVs), such as robotic-delivery cars, self-driving taxis, and driverless long-haul trucks, are driving an increasing number of companies to integrate autonomous technology in their business models.

### SUMMARY

From an electrochemical energy storage device standpoint, the ability to govern the load on a battery through a remote drive cycle and thermal management control is advantageous for increasing the life of the storage device. Embodiments of the present electric vehicle propulsion system for autonomous applications, such as for autonomous vehicles (AV), include at least one core or primary battery component, which can supply power/energy to at least one secondary battery component in such a way that the core component is only fully charged and discharged beneficially once per complete drive cycle, typically one day for AV applications, at a given range of SOC (State-of-Charge). The electrochemical energy storage device described herein is designed such that the primary or core battery component, which may comprise about 75% of the entire electrochemical energy storage device capacity, charges and discharges at rates that do not generate significant internal heat. This permits the primary component to be operated with a passive cooling system, or without cooling, thereby increasing the packing density when compared with a component that requires active thermal management. From an overall capacity standpoint, the primary battery contains the most energy, and eliminating or significantly simplifying the thermal management of this component increases the energy density and reduces the cost of the overall electrochemical energy storage device.

At least one secondary battery component is connected in series with the primary component, and can accept electrical energy from the primary component once the SOC of the secondary component reaches a minimum charge in the range between about 5% and about 20% of capacity, before requiring recharging. A minimum charge between about 0% and about 75% may be employed, but excessive wear on the battery may be a concern. Secondary components employed in accordance with the present invention can also accept energy directed through a component controller from regenerative braking, or other energy recovery processes. However, rates of charge acceptance for the secondary component are kept below the C-rate defined by the battery chemistry selected for a beneficial charge rate of less than 1 C, an acceptable charge rate being less than 2 C, and a maximum charge rate of less than 3 C, to maintain the desired life of this component. Multiple secondary components can be connected in parallel while serially accepting energy from the primary battery. The secondary components can be operated in multiple configurations to provide the required power for propulsion, ancillary, and/or autonomous vehicle functionality. Assuming two such components, and as will be described in detail below, useful configurations include: (1) both providing power simultaneously; (2) one providing power while the second is idle; and (3) one providing power while the second is being recharged by the core battery component. Also, as described in more detail below, it is expected that with these configurations, the AV will be able to complete approximately 15 hr./day daily drive cycles without having to stop due to lack of power in the secondary or tertiary components.

For extending the life of the secondary component to ensure effective performance at end-of-life, active thermal management is supplied to the secondary component(s) to ensure the component(s) does (do) not prematurely degrade due to high temperatures. Active thermal management is common for current electrochemical energy storage devices for the mobility market. As stated above, the present apparatus provides an advantage over current state-of-the-art systems since the portion of the system requiring active thermal management is minimized, as opposed to actively managing the temperature of the entire electrochemical energy storage system. For example, an AV requiring approximately 140 kWh of usable energy would require only 30 kWh, or approximately 20%, for an active thermal management system, in accordance with the present teachings. This is in contrast to state-of-the-art systems, which require a majority or all of the electrochemical energy storage system to have active temperature management. This is a significant advantage in terms of reduced cost, mass, volume, and system complexity.

The core battery can be minimally sized since it only provides for the energy needs of the AV minus that which is supplied in route through energy recovery processes, such as regenerative braking for a predetermined period through remote active drive cycle monitoring and/or governance, before needing recharging, and does not accept or discharge high-current pulses. As will be discussed in more detail below, this permits the primary battery component to optimally meet both the beginning of life and end of life requirements.

At least one tertiary component of the present battery system is employed to accept and discharge electrical energy at high rates from regenerative braking and other energy recovery processes, in order to avoid rapid degradation of the secondary component unless the secondary component is significantly overdesigned to ensure maximum energy recovery efficiency. This ensures that the maximum, if not all, of the energy available through energy recovery processes is captured as it can characteristically offset 20% or more of the daily power demand for AV applications. For example, a characteristic drive cycle can have a daily energy requirement of 125 kWh with approximately 25 kWh hours of energy available for recovery. In accordance with embodiments of the present apparatus, this energy can effectively be recovered without negatively impacting the performance of the overall electrochemical energy storage device; thereby reducing the effective daily energy load to 100 kWh. The benefits of this energy recovery are lower overall cost, lower mass, and smaller volume when compared to current state-of-the-art devices that incorporate higher power and higher energy into a single device. Additionally, the tertiary component will have a passive thermal management system or no thermal management system.

The present AV energy system therefore includes at least one tertiary component, along with associated electrical control systems. Charge acceptance and discharge rates for the tertiary component are unregulated, which will beneficially be placed in parallel to the primary and secondary components. However, there may be applications that would benefit from all components being electrically in parallel, in series, or some combination of the two, as well as applications that have thermal requirements on the tertiary component that may require periodic current regulation.

The present system can be operated as a front or rear drive device, or combined to provide dual drive capability.

In accordance with the purposes of embodiments of the present invention, as embodied and broadly described herein, an embodiment of the apparatus for providing the high-energy and high-power requirements of an electric vehicle having available regenerative electrical energy, hereof, includes: at least one high-power, low-energy density battery being charged by the regenerative electrical energy of the vehicle; at least one high-energy density core battery; at least one intermediate power and energy density secondary battery in series connection with the core battery for receiving electrical energy from the core battery, from the at least one high-power, low-energy density battery, and from the available regenerative electrical energy of the vehicle up to a chosen charge rate, and for providing the acceleration, the electrical load required to support the autonomous functionality, and the ancillary electrical load of the vehicle as required; a cooling system for maintaining the at least one secondary battery at a selected temperature; and a battery controller.

In accordance with the purposes of embodiments of the present invention, as embodied and broadly described herein, an embodiment of the method for electrochemical energy battery charging and use for an electric vehicle having available regenerative electrical energy, hereof, includes: charging at least one core battery when the autonomous vehicle is idle using a charger external to the autonomous vehicle; charging at least one intermediate power and energy density secondary battery in series connection with the at least one core battery, using the at least one core battery; providing propulsion and other electrical requirements of the autonomous vehicle using the at least one secondary battery maintaining the at least one secondary battery at a chosen temperature; charging at least one high-power, low-energy density storage battery from the regenerative electrical energy capability of the autonomous vehicle; providing acceleration requirements of the autonomous vehicle using the high-power, low-energy storage battery; and controlling said steps of battery charging and acceleration, propulsion and other electrical requirements of the autonomous vehicle using a battery controller.

Benefits and advantages of embodiments of the present invention include, but are not limited to, providing an electrochemical energy storage system for autonomous applications, such as AV electric vehicles, that can handle the increase in total energy consumption of the system by including at least one core or primary battery component, which can supply power/energy to at least one secondary battery component in such a way that the core component is only fully charged and discharged beneficially once per characteristic drive cycle, which for AV applications is once per day, with passive cooling, or without cooling, in contrast to state-of-the-art systems that require a majority or all of the electrochemical energy storage system to have active thermal management. This is a significant advantage in terms of reduced cost, mass, volume, and system complexity. The secondary component(s), which is actively cooled, provides the required power for propulsion, ancillary, and/or autonomous vehicle functionality, and represents the component of the system that has the most energy throughput over the life of the electrochemical energy storage device. At least one tertiary component is employed to accept and discharge electrical energy at high rates from regenerative braking and other energy recovery processes, in order to avoid rapid degradation of the secondary component. Additional advantages of embodiments of the present invention include the ability of the primary battery component to optimally meet both the beginning of life and end of life requirements, which further increases the life of the system and decreases cost.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1A is a schematic representation of a PRIOR ART battery system having both high-power and high-energy battery components controlled by a component controller, and a regenerative braking system used to charge both the high-power and high-energy battery components, while FIG. 1B is a schematic representation of state-of-the-art electrochemical energy storage systems where the system is either overdesigned at the beginning of life to ensure compliance with end of life requirements, curve (a), or designed for beginning of life requirements while sacrificing compliance at end of life, curve (b), as compared with the present system curve (c), where the storage system is designed for beginning of life requirements, and the degradation or aging of the system, is controlled to ensure compliance at end of life.

FIG. 2 is a schematic representation of embodiment of the battery system of the present invention illustrating a high-energy component including a primary or core battery and a secondary battery in series electrical connection with each other and with a component controller, with electrical energy from a regenerative energy source being directed by the component controller to charge the secondary battery and tertiary battery, the core battery only being discharged during vehicle operation.

FIG. 3 is a schematic representation of another embodiment of a battery system adapted to provide and receive electrical energy from both front and rear axles of an AV, and having a single core battery, thereby eliminating battery redundancy as the principal cost driver of the battery systems.

FIG. 4 is a schematic representation of the present battery system adapted to provide and receive electrical energy from both front and rear axles of an AV, where the primary component can be distributed throughout the AV.

FIG. 5 is a graph of the state of charge for the core and secondary batteries of an embodiment of the present invention, as a function of autonomous vehicle operating time from a maximum charge to an intermediate value thereof, illustrating the partition of electrical energy between these battery components.

FIG. 6 is a graph of the state of charge for the core and secondary batteries of an embodiment of the present invention, as a function of autonomous vehicle operating time from the intermediate time of FIG. 5 to the minimum state-of-charge for both the core and the secondary batteries, illustrating the partition of electrical energy between these battery components.

FIG. 7 is a graph of the charge acceptance rate or C-rate, as a function of the state of charge for an embodiment of the tertiary battery of the present invention, which is a function of: (a) the SOC; and (b) the charge pulse duration.

FIGS. 8A and 8B are schematic representations showing two secondary battery components operated in four useful configurations, including: (1) both being charged by the core battery, but not powering the vehicle, which is idle (FIG. 8A(a)); (2) both providing power to the vehicle, but not themselves being charged by the core battery (FIG. 8B(a)); (3) one providing power to the vehicle, while the second is being recharged by the core battery (FIGS. 8A(b) and 8A(c)); and (4) one providing power to the vehicle, while the second is idle (FIGS. 8B(b) and 8B(c)).

FIG. 9 is a graph showing that more energy is required above that for the daily drive cycle to power the autonomous and ancillary vehicle functions during vehicle stops to allow the core battery component to recharge the secondary battery component, along with the significant degradation of a single secondary battery component having lower capacity as illustrated in FIG. 9(a), when compared to a higher capacity secondary component, as shown in FIG. 9(b).

FIG. 10 is a graph showing characteristic voltage profiles for two secondary battery components configured in parallel with each other and serially with the core battery storage component, with curve (a) showing one of the secondary components initially providing power to the vehicle in concert with the tertiary component, while curve (b) shows the other secondary component starting out as idle, and then providing power to the vehicle as the depleted secondary component is being charged by the core battery component as described in FIGS. 8A and 8B above.

FIGS. 11A and 11B are graphs of capacity retention plots for both the secondary and core battery components, respectively, that track the degradation of these components over the four-year life of the electrochemical energy storage device when operating under a characteristic autonomous vehicle drive cycle, assuming both front and rear drive propulsion (curves (a) and (b), respectively, of FIG. 11A)

### DETAILED DESCRIPTION

As stated, successful electrification for autonomous applications, and specifically autonomous vehicles (AVs), requires an increase in the performance of current state-of-the-art electrochemical energy storage devices, along with reduction in cost of these devices to ensure economic viability. Embodiments of the invention described herein addresses these performance and cost issues by employing a hybrid battery system that can satisfy the energy and power requirements for a number of emerging electrification markets. Embodiments of the present invention may be applied to AVs, in addition to the mining industry, to stationary electrical storage for home use, and to electrical grid storage, as examples. Autonomous vehicles are used throughout to describe and illustrate these embodiments.

Current state-of-the-art electrochemical energy storage devices using a single chemistry are unable to provide the energy and power densities required to fully automate the operation of commercial and passenger vehicles over the lifetime of the vehicles. This inability results from the characteristic nature of energy consumption for autonomous applications when compared with traditional automobile applications. That is, the amount of time which an autonomous vehicle (AV) is using power from the electrochemical storage device, either by providing power to the vehicle, or recovering energy through energy recovery processes such as regenerative braking, is greater when compared to passenger vehicles. For example, characteristic daily drive cycles can result in the vehicle operating on the order of 15 hours per day, with a consumption of greater than 100 kWh of energy daily. Additionally, the magnitude of the power pulses for driving AV applications is higher when compared to current passenger vehicles. Thus, the total energy consumption for autonomous vehicle operation is significantly increased, and AV applications need both high energy and high power.

Existing single chemistry battery systems are high-energy/low-power in order to support propulsion energy requirements before recharging, and cannot accept high-power or high-current pulses, which cause accelerated device degradation. The traditional approach is to overdesign the high-energy component with a single chemistry and a single cell design so the current pulses will not result in damage to the core component, and to ensure end-of-life energy, sufficient cycle life, power, and functional safety requirements are met. Since they are oversized to meet end-of-life requirements, such larger systems are more costly, take up more space, and require more elaborate thermal control strategies. Moreover, this results in inefficient recovery from regenerative braking, as an example, when this energy could be more efficiently utilized for vehicle propulsion or other ancillary applications. For AVs to achieve widespread adoption for commercial applications, low cost of ownership energy solutions containing both high energy density and high-power characteristics for propelling vehicles and driving onboard electronics and sensors are needed.

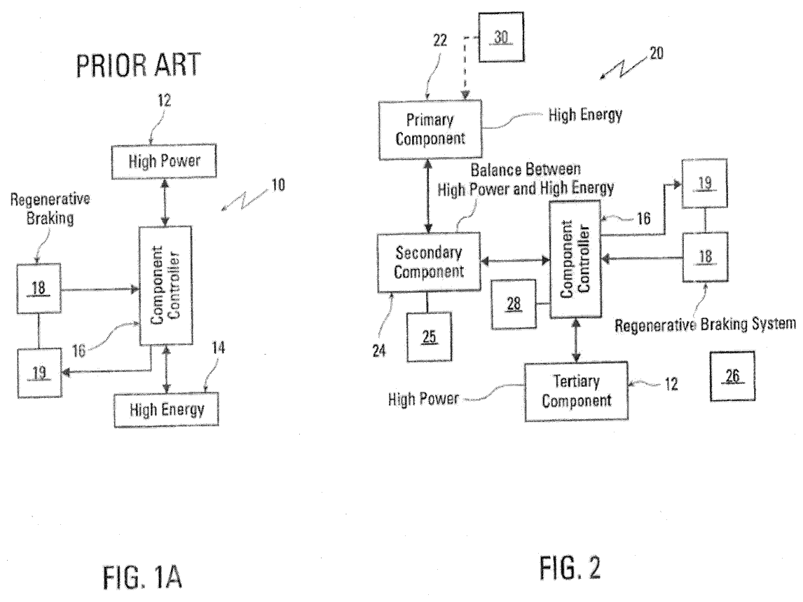

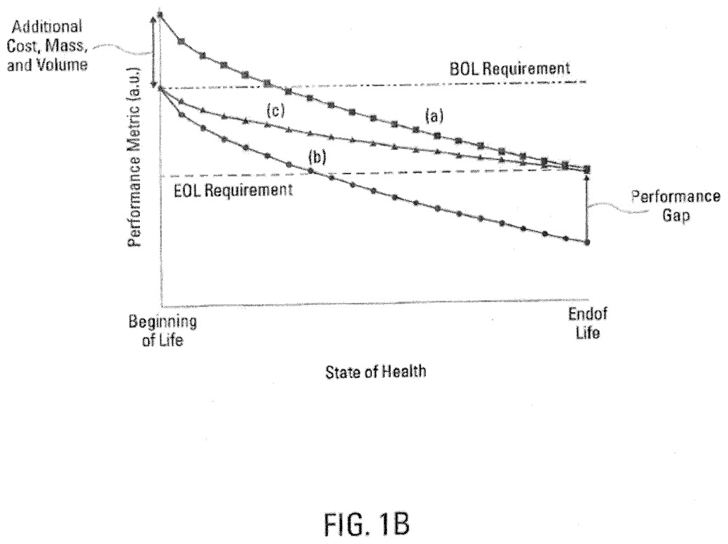

Energy storage systems having both high-energy for extended vehicle range of operation, and high-power for vehicle acceleration or heavy load conditions are known. FIG. 1A is a schematic representation of a PRIOR ART battery system, 10, having both high-power, 12, and high-energy, 14, battery components controlled by component controller, 16. Recharge electric power from regenerative braking system, 18, of vehicle, 19, as an example, is shown being used to charge both the high-power 12 and high-energy 14 battery components. Component controller 16, may also be used to drive the electric motors of vehicle 19 when current flows from the batteries thereto. Suitable electrically rechargeable high-energy density batteries may include, for example, lithium-ion batteries, solid-state batteries having various chemistries, such as sulfide, polymer, oxide, or a combination thereof, nickel-metal-hydride batteries, and sodium-nickel-chloride batteries.

FIG. 1B, is a schematic representation of state-of-the-art electrochemical energy storage systems where the system is either overdesigned at the beginning of life to ensure compliance with end of life requirements, curve (a), which shows the simulated performance to achieve the desired end of life performance, or designed for beginning of life requirements, while sacrificing compliance at the end of life, curve (b) that shows the simulated performance to achieve the desired beginning of life performance. Curve (c) shows the simulated present storage system, where the system is designed for beginning of life requirements, and the degradation or aging of the system, is controlled using optimized energy and power partitioning using governed drive cycle/electrochemical loading to ensure compliance at end of life.

TABLE 1 sets forth battery characteristics for current automotive use when compared to those expected for AV applications.

TABLE 1

| Battery | | |
|---|---|---|
| Characteristics | Current Automotive | Autonomous Vehicle |
| Cycle Life | ~2000 cycles to 80% | ~6000 cycles to 80% |
| | capacity (~350 cycles/yr.) | capacity (~1500 |
| | | cycles/yr.) |
| Energy Density | Function of Use | High Energy Density |
| | (Start/Stop ~100 Wh/kg; | ~250-300 Wh/kg |
| | PHEV ~200 Wh/kg; | |
| | EV ~200-300 Wh/kg) | |
| Power Density | 1-3 C Charge | C/2 Charge (1000-7000 |
| | (Start/Stop ~7000 W/kg; | W/kg needed for device |
| | PHEV ~2500 W/kg; | loads and REGEN |
| | EV ~1000 W/kg) | braking) |
| Cost | EV < $100/kWh | ~$100/kWh |
| Life | 8-10 years | 4 years (~24,000 hrs.) |
| | | Used about 70% of |
| | | each day |

Thus, commercial implementation of AVs will place greater demand on electrochemical storage devices, both from a performance and cost standpoint, by significantly increasing the performance requirements over those for the current commuter automotive industry, while maintaining the current cost at the cell level. Operation of large AV fleets will require that vehicles are in service for a significant portion of their operational lifespan; that is, the battery pack will have to last for approximately 4 years under almost constant use. Estimates place the demand on the battery pack at 24,000 hours and 400,000 miles over the 4-year period, while maintaining ≥80% of its initial capacity. As current EV/PHEV (electric vehicle/plug-in hybrid electric vehicle) systems are designed to meet the drive train requirements and last approximately 8-10 years and 100,000 miles, which is 25% of the mileage demand for AV applications, the more aggressive performance targets for autonomous fleet applications cannot be achieved using current battery pack designs. Current automotive requirements for applications ranging from 12 V lithium-ion starter batteries, to 48 V start/stop micro-hybrid systems, through plug-in hybrids and completely electric systems, do not singularly reach the performance and cost needs for autonomous applications.

In order to meet this change in requirements, embodiments of the present invention partition energy consumption into three storage devices having different performance characteristics that can effectively handle the vehicle propulsion, ancillary systems, and AV operation load throughout the operating life of the vehicle. Briefly, embodiments of the present invention include an apparatus and method for electrochemical energy storage for autonomous vehicles having remote active drive cycle monitoring and/or governance, as well as and thermal management control. The apparatus may include: (1) a high-power, low-energy density tertiary storage battery having low cost, and designed to wear and be replaceable; (2) a high-energy density core battery, or primary component; (3) an intermediate power and energy density secondary battery for buffering the load on the core battery; and (4) a battery controller. As will be described in more detail below, the AV energy requirement and consumption rate are provided in such a manner that performance degradation over the life of the system is reduced. Several battery chemistries are envisioned.

An example of the manner in which the multiple energy storage devices may function together is that the core or primary component can supply power/energy to the secondary component in such a way that the core component is only fully charged and discharged ideally once per drive cycle, a characteristic drive cycle for AV applications being once per day, at a chosen SOC (State-of-Charge) range between about 10% and about 95% to avoid battery degradation. Operationally, the core battery can be charged at an SOC in the range between about 0% and about 100%, if degradation is not a concern. The secondary component can be disposed in series with the primary component and can accept energy from the primary component once the secondary component's SOC reaches a minimum value in the range between about 5% and about 20%, before needing recharging. A minimum charge between about 0% and about 75% may be employed, before recharging, but again battery degradation may be a concern. The secondary battery can also accept energy directed through the component controller from regenerative braking, or from excess energy stored in the tertiary component. Rates of charge acceptance for the secondary component are limited to the rated C-rate defined by the battery chemistry, which is selected to be less than about 1 C. Acceptable charging rates may be up to about 2 C, but the maximum charge rate should be less than 3 C, to ensure a reasonable life of the secondary component.

Note that the charging and discharging of batteries are determined by C-rates relative to their maximum capacity, where the capacity of a battery is commonly rated at 1 C, which means that a fully-charged battery rated at 1 Ah should provide 1 A for one hour at which time the battery is discharged. The same battery discharging at 0.5 C should provide 500 mA for two hours, and at 2 C delivers 2 A for 30 min.

To accommodate long daily drive cycles, multiple secondary battery components can be disposed in parallel while serially accepting energy from the primary battery when the SOC for each battery reaches a minimum value, as set forth above. This configuration ensures that the vehicle can complete the entire drive cycle without stopping, and not draw power for vehicle propulsion from the core battery component, which can cause accelerated degradation of the core battery component. The secondary components can be operated in multiple configurations to provide the required power for propulsion, ancillary, and/or autonomous vehicle functionality. These configurations include: (1) the multitude of secondary battery components simultaneously providing power to the AV, and accepting regenerative energy simultaneously; (2) one secondary component providing power and accepting regenerative energy, while a second is idle at an SOC that is somewhere between the minimum SOC defined above and its fully charged state; and (3) one secondary battery component providing power, while a second battery is being recharged by the core battery component and has an SOC between the minimum value and fully-charged SOC, as defined above.

The tertiary battery component can accept energy at high rates, and is chosen to provide maximum efficiency for regenerative breaking. Charge acceptance and discharge rates for this component will be high, and need not be unregulated. As an example, the tertiary system may be a lithium ferrophosphate (LFP), or other high-rate capable cathode, with a graphite anode and thermally stable liquid electrolyte, and can be wired in parallel to the primary and secondary batteries. However, there may be applications that would benefit from all of the components being in parallel, in series, or a combination of the two, with another battery chemistry that achieves the high-rate capability requirement.

In a single drive train system, either the front wheels or the rear wheels are driven, while a dual drive train drives both front and rear wheels, and requires multiple energy storage devices. The more demanding operating conditions for AVs, such as driving time, increased power intensity, and energy required for propulsion, are available throughout the life of the energy storage device, and the multiple energy storage devices and chemistries, which reduce performance degradation over the life of the system, can be applied to front or rear drive vehicles, and dual-drive systems.

To extend the life of the secondary component to ensure effective performance at end of life, it is expected that the secondary component(s) will require active thermal management to ensure the component does not degrade prematurely due to high temperatures. It is also expected that the core and tertiary component will have a passive thermal management system or no thermal management system. This is enabled by the fact that the core battery component charges and discharges at rates that do not generate significant internal heat. Active thermal management is common for current electrochemical energy storage devices for the mobility market. Embodiments of the present invention provide an advantage as active thermal management is minimized. This is in contrast to current systems that would require a majority or all of the electrochemical energy storage system to be actively managed. This advantage affords significant reductions in cost, mass, volume, and system complexity.

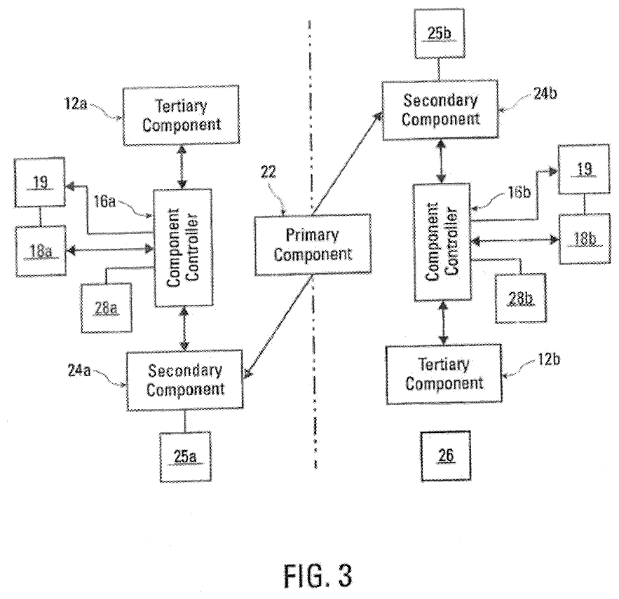

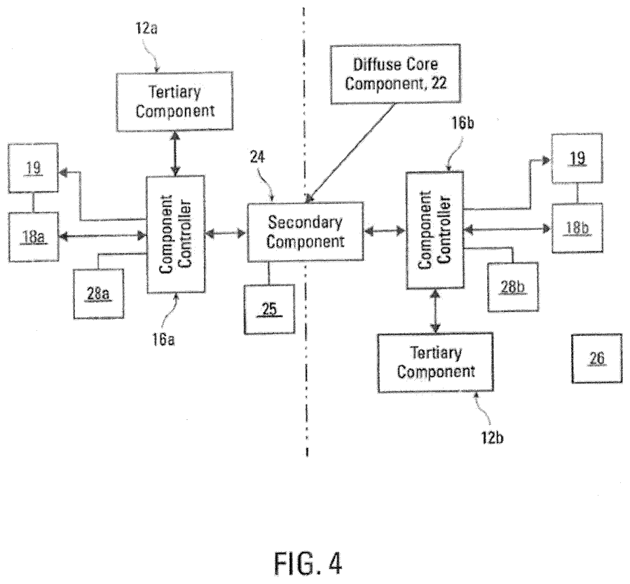

Reference will now be made in detail to the present embodiments of the invention, examples of which are illustrated in the accompanying drawings. In the Figures, similar structure will be identified using identical reference characters. It will be understood that the FIGURES are presented for the purpose of describing particular embodiments of the invention and are not intended to limit the invention thereto. Turning now to FIG. 2, illustrated is a schematic representation of embodiment, 20, of the battery system of the present invention. High-energy component 14 includes primary or core battery, 22, and secondary battery or component, 24, in series electrical connection with each other and with component controller 16. Electrical energy from regenerative energy source 18, for example, from regenerative braking, is directed by component controller 16 to charge secondary component or battery 24 and tertiary component or battery 12. Component controller 16, drives the electric motors of vehicle 19, as well as providing other electrical requirements thereof, when current flows from secondary battery 24 thereto. Secondary battery 24 is the component of embodiment 20 that has the most energy throughput over its life, and is kept at a chosen temperature by temperature controller, 25. Remote active drive cycle governance instructions to the AV are transmitted from transmitter/receiver, 26, and received by receiver/transmitter, 28, for remotely governing component controller 16, among other functions of the AV, and AV monitoring information is received from the AV by transmitter/receiver 28, and transmitted to transmitter/receiver 26. Although FIGS. 3 and 4, hereof, show reference characters 28a and 28b indicating two transmitter/receivers, one for each of the front and rear drive systems, in many situations, a single transmitter/receiver is used.

In accordance with the teachings of embodiments of the present invention, core battery 22 is only discharged during vehicle operation, during which time it recharges secondary battery 24, while regeneration charging occurs during vehicle operation as well, for secondary battery 24 and tertiary battery 12. Core battery 22 is typically charged during idle time of the AV at the end of a drive cycle, by external charger, 30. In the situation where energy is exchanged between both front and rear axles and the battery systems of the vehicle in a dual drive AV, there will be two component controllers, one for each axle, two secondary batteries and two tertiary batteries, again one of each type for each axle. There may also be two primary batteries.

FIG. 3 is a schematic representation of another embodiment of the present battery system adapted to provide and receive electrical energy from both front and rear axles of an AV. Electrical regenerative energy source, 18a, derives energy from the front axle of AV 19, which is directed by component controller, 16a, into tertiary battery 12a and temperature-controlled (25a) secondary battery, 24a, while regenerative energy source, 18b, derives energy from the rear axle thereof, which is directed by component controller, 16b, into tertiary battery, 12b, and temperature-controlled (25b) secondary battery, 24b. In this embodiment, the primary or core component 22 will have to be of higher capacity when compared to the two separate axle or dual drive embodiment of the AV; however, eliminating battery redundancy will be beneficial since the primary component will be the principal cost driver of the battery systems.

An additional embodiment of the invention described herein is illustrated in FIG. 4, which is a schematic representation of the present battery system adapted to provide and receive electrical energy from both front and rear axles of an AV, where primary component 22 can be distributed throughout AV 19. This results in passive thermal management of primary battery component 22 since the cells that comprise the battery component are not confined to a central location, which ensures effective heat transfer in order to reduce premature battery degradation. To ensure safe and reliable operation of a diffuse primary battery component, abuse-tolerant cell components would be employed that are resistant to collisions, as an example, which may otherwise crush or penetrate the cells, causing a fire. Another benefit of using a diffuse primary battery component is the ability to access and replace a module or module(s) containing cells if there is a premature failure. Active module or cell balancing to account for differences in module resistance would also be required for effective and safe operation if a module or module(s) were replaced. This is advantageous over current state-of-the-art systems as these technologies require that the entire electrochemical energy storage system to be replaced if a component prematurely ages at extensive cost.

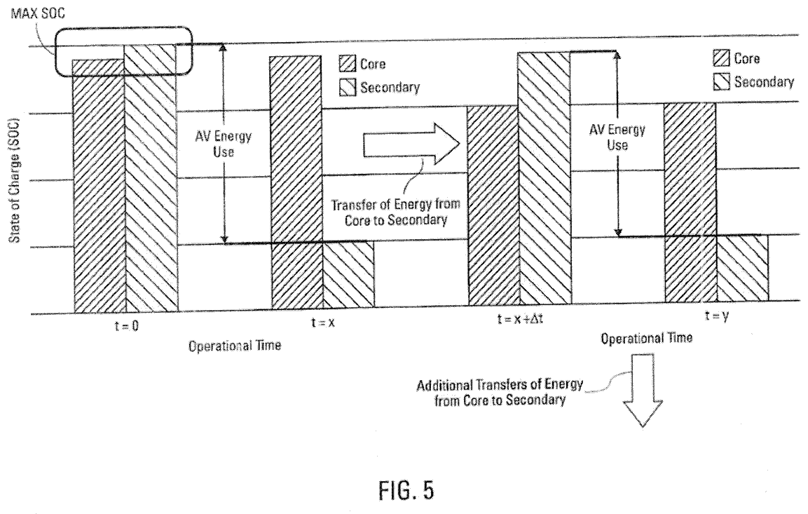

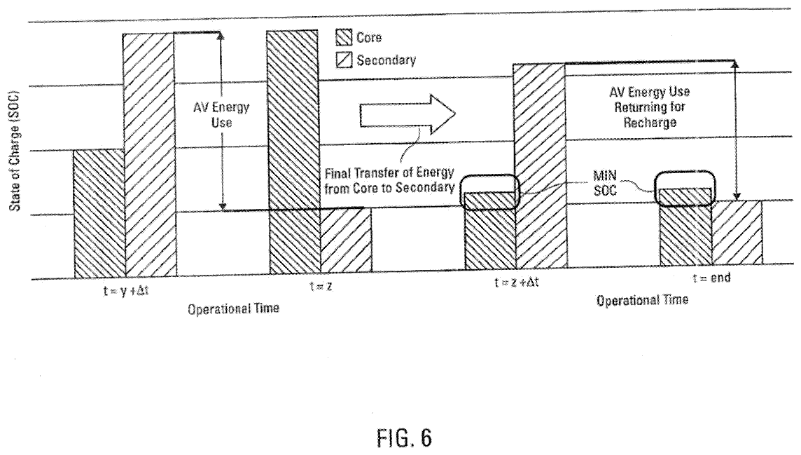

In use, the partition of electrical energy entering and leaving the battery system for the embodiment of the invention illustrated in FIG. 2 is shown in FIGS. 5 and 6. Turning now to FIGS. 5 and 6, charging core battery 22 only occurs at a chosen C-rate, depending on the battery, for which the C-rate range is beneficially between about C/5 and about C/10, with an acceptable range being between about C/3 and about C/20, with the operable range being between about 1C and C/50, during times when the vehicle is not in operation (t=0). Core battery 22 is used for two situations: (a) for recharging the secondary component of apparatus 20 upon reaching a chosen minimum state-of-charge (SOC) of secondary battery 24, as described above; and (b) transferring energy to propulsion or ancillary functions if secondary battery 24 fails in order to ensure the operation and functional safety of the AV, in which situation the AV would be instructed to return for maintenance.

If the state-of-charge (SOC) of secondary battery 24 of apparatus 20 is less than or equal to a chosen SOC value, as defined above, corresponding to times, t=x, y, or z as illustrated in FIGS. 4 and 5, secondary battery 24 is recharged at maximum C-rate consistent with the capabilities of core battery 22 of apparatus 20. The current associated with a C-rate of core battery 22 will not be equivalent to that of secondary battery 24. It is advantageous that a current calculated for a chosen C-rate for core battery 22, if used to calculate the C-rate for secondary battery 24 will result in a higher C-rate; that is, a chosen current C-rate for core battery 22, is less than the C-rate for secondary battery 24.

If the SOC is less than or equal to the chosen SOC value for secondary battery 24, as defined above, corresponding to times, t=x, y, or z, as illustrated in FIGS. 4 and 5, current is accepted from core battery 22 of apparatus 20 (which may be at varying time intervals, depending on the operation of the AV, and may not be continuous) until the desired SOC, advantageously in the range between about 95% and about 80%, with the operable range being between about 100% and about 25%, as defined at times corresponding to t=x+Δt, y+Δt, or z+Δt, as illustrated in FIGS. 5 and 6, is reached. If the SOC is greater than or equal to the chosen SOC value, also advantageously in the range between about 95% and about 80%, with the operable range being between about 100% and about 25%, corresponding to times, t=x, y, or z, as illustrated in FIGS. 5 and 6, AND the specified C-Rate is less than or equal to that highlighted in the TABLE 2, then current is supplied for propulsion and ancillary functions at the specified current. A battery management system (BMS), included in component controller 16, may be employed to calculate the SOC of the primary and secondary components to ensure proper function and operational control of the SOC range for each component. Additionally, it may be beneficial to employ active cell balancing for the secondary component to increase component life. The requirement for active balancing can be determined by the drive cycle and the aging properties of the chemistry employed in the secondary battery, since the cells age at different rates changing their internal impedance, which disrupts their mutual balancing.

If the SOC is greater or equal to the chosen value for tertiary battery 12 for which the range is advantageously between about 30% and about 100% of the total charge of the battery, with an operational range between about 10% and about 100%, based on the design of the battery pack, then current may be applied to vehicle 19 for propulsion and ancillary functions. If the SOC of tertiary battery 12 is less than the chosen value set forth above, AND the C-rate is greater than or equal to the maximum C-rate as defined above for secondary battery 24 of apparatus 20, as defined in TABLE 2, below, then current is applied for propulsion and ancillary functions until the C-rate falls below the threshold for secondary battery 24 at which time secondary battery 24 can take over the load from tertiary battery 12. If the SOC is less than the chosen value stated above, AND the C-rate is less than the maximum C-rate as defined for secondary battery 24 of apparatus 20, as defined in TABLE 2, current should not be discharged from tertiary battery 12 of apparatus 20; rather, current should be supplied from secondary battery 24 of apparatus 20.

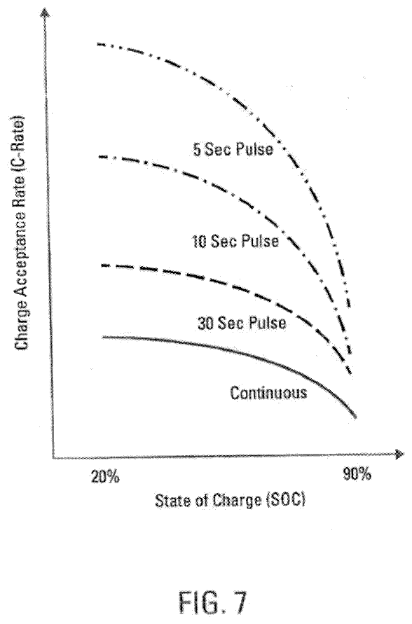

In order to optimize the energy recovery efficiency from regenerative braking for the embodiment of the invention illustrated in FIG. 2, the tertiary battery is employed. FIG. 7 is a graph of the charge acceptance rate or C-rate, as a function of the state of charge for an embodiment of the tertiary battery of the present invention, which is a function of: (a) the SOC; and (b) the charge pulse duration. To be noted is that quantifiable C-Rates and exact slopes as a function of SOC and charge pulse will be a function of the cells that comprise the tertiary battery, and, as described above, limits on the charging C-rate can be eliminated if needed to ensure the regenerative energy is effectively recaptured.

It may be observed from FIG. 7 that: (a) the charge current rate (or magnitude of the charge current) can be increased as the state-of-charge (SOC) of the battery (preferably at the cell level) decreases; AND (b) the charge current rate increases, regardless of the SOC as the duration of the charge pulse decreases. The increase in the charge current from high to low SOC is seen to be nonlinear; therefore, in order to maximize the efficiency of energy recovery, the increase in slope is maximized at high SOC in order to reach the maximum charge acceptance rate, or close thereto for a given pulse length, at the optimized SOC.

To effectively implement this embodiment, a BMS, also included in component controller 16, may be employed to calculate/predict the SOC of the tertiary component, AND the cells that comprise the tertiary component should be well balanced. Additionally, active balancing may be combined with this embodiment to promote more effective energy recovery and extend the life of the component.

Having described the general details of embodiments of the present invention, the following EXAMPLES provide additional details.

### Example 1

TABLE 2 provides sample ranges for the power and energy densities of the primary or core, secondary, and tertiary batteries of embodiments of the present invention, which differ significantly since AV applications require both high energy and high power. It should be noted that these are advantageous ranges and are provided as examples, but are not intended to limit the scope of application of embodiments of the present invention.

TABLE 2

| Performance | Core | | Secondary | Tertiary |
|---|---|---|---|---|
| Metrics | Battery | | Battery | Battery |
| Energy Density | >280 | | 180-210 | 110-140 |
| (Wh/kg) | | | | |
| Power Density | 500-1000 | | 2000-3000 | 5000-7000 |
| (W/kg) | | | | |
| Capacity (Ah) | >75 | | 30-55 | 20-40 |
| Discharge Rate | ≤0.5 | C | 4-6 C | 10-30 C |
| Charge Rate | 0.1-0.5 | C | 1-3 C | 3-5 C (higher |
| | | | | for shorter |
| | | | | pulses) |

| | | | |
|---|---|---|---|
| Cycle Life | >1200 (85% | >4000 | >3000 (60% |
| (cycles) | usage) | (controlled | Capacity |
| | | SOC range) | Retention) |
| Effective | High Nickel | Low Nickel | LFP |
| Chemistries | NMC/Solid | NMC | |
| | State | | |

As stated, the traditional approaches have been to over-design the high-energy batteries having a single chemistry and a single cell design so that high-current pulses (high power) do not result in damage to the core battery. Since high current is relative, the higher the capacity of the core component, the higher the absolute magnitude of the current pulse can be and still result in a low rate when compared to the overall capacity of the core component. However, the extra battery capacity required to keep this rate low means extra cost, extra weight, and extra volume; all of which are barriers to widespread adaption for AV applications. In accordance with the teachings of embodiments of the present invention, the core component can be minimally sized, thereby reducing cost, in order to simply supply the energy needs of the device (AV) for a predetermined operational time before recharging. Under these operating conditions, the core component never accepts or discharges a high current pulse. Additionally, this predetermined operation time is not previously present in passenger or commercial vehicles, because the remote active drive cycle monitoring and/or governance is new to AV.

The secondary battery is chosen such that it can tolerate higher current pulses for an extended period of time. This component can deliver this current at a constant rate which is effective for the propulsion of the vehicle at low-to-moderate acceleration rates or at constant speeds. As described above, once this battery is drained to a predetermined state-of-charge value, the core battery provides the energy to charge the secondary battery with which it is in series electrical communication. Also, as mentioned above, other electrical configurations are anticipated. This charging process can occur multiple times during the continuous operation of the AV. The secondary battery can supply current to ancillary devices, AV functionality operating the vehicle, and for controlling vehicle climate, as examples, if needed. Optimally, this is supplied when those components are operating at a steady state so that the current magnitude is low and steady.

The tertiary component is chosen such that high rates of charging and discharging can be tolerated without shortening the life of the battery and, as such, this battery is effective for leveling off current surges (for example, from fast breaking that will supply a large current for a short time through regenerative breaking, or when the vehicle needs to accelerate quickly, thereby requiring large current input to the electric drive train largely from the battery). For charging, the larger the current pulse that can be applied, the more efficient the energy recovery is, which in turn reduces the wear (thereby increasing the life) on the core and secondary batteries. This battery can also supply the required current for ancillary devices, both as surges and at steady-state to ensure proper operation as well as to provide excess energy to the secondary battery.

### Example 2

TABLE 3 compares battery capacity (Ah), cost, and volume (L) for the battery system of embodiments of the present invention, comprising a core, a secondary, and a tertiary battery, with the potential of having different battery chemistries and cell designs, with a traditional battery system having one cell chemistry and one cell design. It may be observed from TABLE 3 that the battery system of the present invention may be constructed with lower capacity, at lower cost and with smaller volume than the traditional, over-designed core battery.

TABLE 3

| | | | |
|---|---|---|---|
| Core | Secondary | Tertiary | Total |

CAPACITY (Ah)

| | | | | |
|---|---|---|---|---|
| Present | 120 | 30 | 21 | 171 |
| Invention | | | | |
| Traditional | 286 | N/A | N/A | 286 |

COST (USD)

| | | | | |
|---|---|---|---|---|
| Present | 6,720 | 1,890 | 250 | 8,860 |
| Invention | | | | |
| Traditional | 16,000 | N/A | N/A | 16,000 |

SIZE (L)

| | | | | |
|---|---|---|---|---|
| Present | 65 | 21 | 4 | 90 |
| Invention | | | | |
| Traditional | 154 | N/A | N/A | 154 |

Information used in the calculations for quantifying the benefits of the present invention over a current state-of-the art or traditional batteries is as follows:

(a) Traditional battery is based off a 100 kWh design (a common pack capacity for current commuter electric vehicles (EVs));

(b) Traditional battery and core battery voltages were assumed to be 350V (again, a characteristic value for a common EV battery pack, with a voltage range between 350V and 400V);

(c) Cost and volumetric energy densities for traditional and core batteries was $160/kWh and 650 Wh/L, respectively;

(d) While the traditional and core batteries perform different functions, materials used, cell design and cost per Wh are similar;

(e) The secondary battery of the present invention has a higher power density, but a lower energy density, and is therefore less cost effective per Wh;

(f) Values used to calculate cost and volume are $180/kWh and 500 Wh/L, respectively;

(g) The tertiary battery has the highest power density and the lowest energy density, making it the least effective from a cost and space perspective when normalized by Wh;

(h) Values used to calculate cost and volume are $250/kWh and 250 Wh/L, respectively, coincidently the same values; and

(i) Total capacity of the batteries of the present invention can be reduced because the vehicle utilizes energy more efficiently due to effective energy recovery of embodiments of the present invention during operation, controlled and effective partitioning of the electrical load, and controlled drive cycle conditions afforded by AV applications. That is, the battery pack energy of the present invention is sufficient to ensure that the vehicle is capable of continuous operation for a single day, and NOT overdesigned for power as the present tertiary and secondary batteries are more effective for providing and receiving such energy without causing cell level damage.

### Example 3

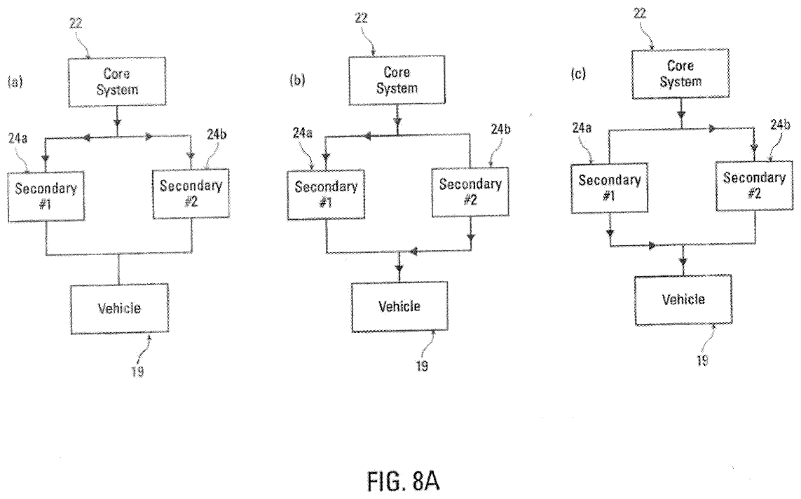

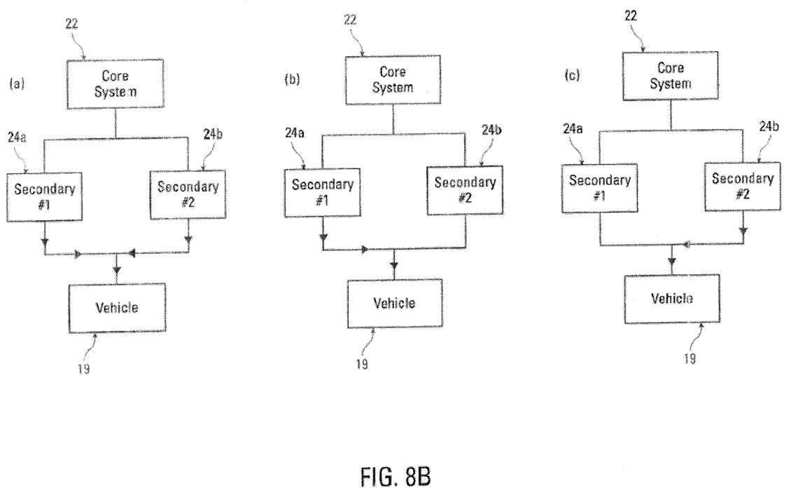

A characteristic autonomous vehicle drive cycle assuming both front and back propulsion has been utilized to determine the regeneration energy recovery efficiency and the degradation of the secondary battery component. Attributes of the drive cycle are set forth in TABLE 4. Additionally, the simulations tracked (1) the percent of the drive cycle that was completed, with less than 100% completion deemed unacceptable; (2) the percentage of regeneration energy recaptured, with the goal of 100% recapture and use for propulsion, autonomous, and ancillary vehicle functions; (3) energy of the secondary battery component, with the goal of minimizing the size of the secondary component since active thermal management is needed, while the primary and tertiary battery components do not. Additionally, two electrochemical energy storage device configurations were modeled, with one configuration containing a single secondary battery component and the second configuration containing two secondary battery components placed in parallel with each other, while in series with the core battery component as illustrated in FIG. 8.

FIGS. 8A and 8B are schematic representations showing two secondary battery components operated in four useful configurations, for providing the required power for AV propulsion, ancillary, and/or autonomous vehicle functionality, while ensuring power from the secondary component to the vehicle is uninterrupted during one complete drive cycle, including: (1) both being charged by the core battery, but not powering the vehicle, which is idle (FIG. 8A(a)); (2) both providing power to the vehicle, but not themselves being charged by the core battery (FIG. 8B(a)); (3) one providing power to the vehicle, while the second is being recharged by the core battery (FIGS. 8A(b) and 8A(c)); and (4) one providing power to the vehicle, while the second is idle (FIGS. 8B(b) and 8B(c)). Use of additional secondary batteries is contemplated, as will be discussed below.

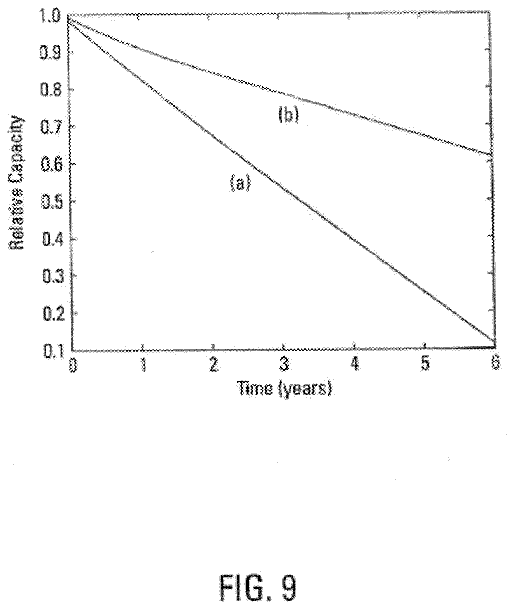

Findings from the simulations are that a single secondary battery component configuration requires a higher percentage of the overall electrochemical energy storage capacity to complete the entire daily drive cycle and to recover all of the regenerative energy. A summary of these results is contained in TABLE 5. In addition, approximately 12% more energy is needed above that for the daily drive cycle to power the autonomous and ancillary vehicle functions during vehicle stops to allow the core battery component to recharge the secondary battery component. This additional energy requirement along with the significant degradation of a single secondary battery component having lower capacity is illustrated in FIG. 9(a), when compared to a higher capacity secondary component, as shown in FIG. 9(b), and demonstrates a potential advantage of the multiple secondary battery component configuration described above.

TABLE 4

| Performance | | | | | | |
|---|---|---|---|---|---|---|
| Characteristic | Front Axle | | Rear Axle | | Total | |
| Time* | >15 | hrs/day | >15 | hrs/day | >15 | hrs/day |
| Energy | >60 | kWh | >60 | kWh | >120 | kWh |
| Regeneration | >10 | kWh | >10 | kWh | >20 | kWh |
| Energy Available | | | | | | |
| Total Energy | >50 | kWh | >50 | kWh | >100 | kWh |
| Required** | | | | | | |

Note
*Front and Rear axle are providing propulsion simultaneously
Note
**Assumes all available regeneration energy is recaptured

TABLE 5

| Secondary Battery | Regeneration | Drive Cycle |
|---|---|---|
| Component | Energy Recovery | Completion |
| (% total capacity) | (% of total) | (% of total) |
| 11.4% | 75.3% | 77.9% |
| 20.2% | 89.2% | 89.7% |
| 22.2% | 92.4% | 92.9% |
| 27.7% | 98.1% | 97.9% |
| 29.9% | 100% | 100% |

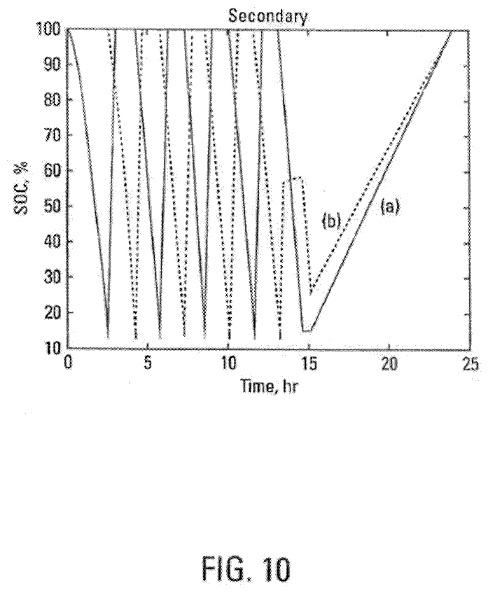

FIG. 10 is a graph showing characteristic voltage profiles for the secondary battery component when two batteries of approximately 10% of the total electrochemical energy storage capacity (20% total) are configured in parallel with each other and serially with the core battery storage component. Curve (a) shows one of the secondary components initially providing the propulsion, autonomous operation, and ancillary function energy in concert with the tertiary component as defined by the portioning logic described above, while curve (b) shows the other secondary component starting out as idle, and then providing power to the vehicle while the depleted secondary component is charged by the core battery component as described in FIGS. 8A and 8B above.

Advantages for this characteristic autonomous vehicle use are: (1) all additional energy requirements associated with autonomous and ancillary functions while the vehicle is stopped to recharge the secondary battery component are eliminated, thereby minimizing the total energy required to complete the daily drive cycle; (2) all regeneration energy can be recovered while completing the daily drive cycle when in comparison to the single secondary battery component comparison, 30% of the total energy capacity is required as highlighted in TABLE 5; (3) degradation of the secondary battery component is reduced to between 65 and 70% of the original component capacity when compared to approximately 30% in the single secondary component configuration at the end of the four year life of the electrochemical energy storage device; and (4) the relative capacity of the core battery component is predicted to be approximately 84% of its original capacity at end of life (four years), thereby exceeding the end of life requirement. These predicted values outperform current state-of-the-art as the total energy of the devices are calculated to be approximately equivalent, but the capacity retention at the end of four years is predicted to be approximately 77% of the initial capacity. This in addition to the fact that the current state-of-the-art requires thermal management of the entire electrochemical energy storage device while the invention described herein requires thermal management of approximately 20% of the total energy contained in the electrochemical energy storage device highlights the clear advantage of this invention's teachings.

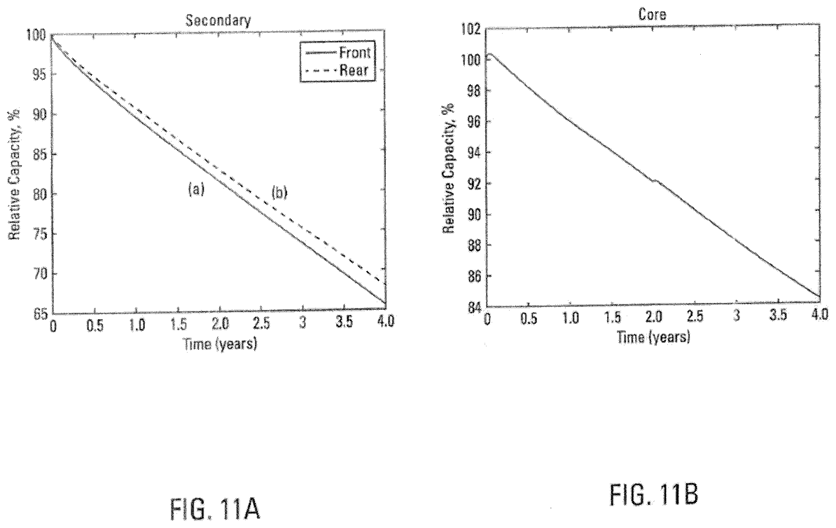

FIGS. 11A and 11B are graphs of capacity retention plots for both the secondary and core battery components, respectively, that track the degradation of these components over the four-year life of the electrochemical energy storage device when operating under a characteristic autonomous vehicle drive cycle, assuming both front and rear drive propulsion (curves (a) and (b), respectively, of FIG. 11A). Curves (a) and (b) of FIG. 11A indicate that the electrochemical energy storage device has two secondary components for which the front and rear component capacity retention curves are slightly different as a result of the simulated loads from the characteristic drive cycle placed on these components varying as dictated by the autonomous operation. The core battery component capacity retention curve when applying the characteristic autonomous vehicle drive cycle and operated using the embodiments of the present invention demonstrates that greater than 80% capacity retention, an important end of life performance metric, can be achieved as the life simulations predict greater than 84% retention at four years.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for electrochemical energy storage for an autonomous electric vehicle having regenerative electrical energy capability, comprising:
at least one high-power, low-energy density storage battery capable of providing acceleration and other electrical requirements of said autonomous vehicle, and for receiving charging from said regenerative electrical energy capability of said autonomous vehicle;
at least one high-energy density core battery;
at least one intermediate power and energy density secondary battery in series connection with said at least one core battery for receiving electrical energy from said at least one core battery, and for providing propulsion and other electrical requirements of said autonomous vehicle;
a thermal management system for maintaining said at least one secondary battery at a chosen temperature; and
a battery controller.

2. The apparatus of claim 1, further comprising a transmitter for transmitting remote drive cycle governance instructions to said autonomous vehicle, and a receiver for receiving the drive cycle governance instructions and for implementing said drive cycle governance instructions in said autonomous vehicle.

3. The apparatus of claim 1, further comprising a transmitter for receiving monitoring information from said autonomous vehicle, and a remote receiver, wherein said transmitter transmits the monitoring information to said remote receiver.

4. The apparatus of claim 1, wherein said at least one secondary battery receives charging from said regenerative electrical energy capability of said autonomous vehicle in addition to receiving electrical energy from said at least one core battery.

5. The apparatus of claim 1, wherein said battery controller controllably distributes electrical load of said autonomous vehicle to said at least one core battery, to said at least one secondary battery, and to said at least one high-power, low-energy density storage battery, to satisfy both beginning-of-life and end-of-life requirements of said at least one core battery, said at least one secondary battery, and said at least one high-power, low-energy density storage battery.

6. The apparatus of claim 5, wherein the electrical load distribution to said at least one core battery is achieved for a state-of-charge range between about 10% and about 95%, and the electrical load distribution to said at least one secondary battery is achieved at a minimum state-of-charge range between about 5% and about 20%, such that said at least one core battery provides electrical energy to said at least one secondary battery.

7. The apparatus of claim 6, wherein said at least one secondary battery receives electrical energy from said at least one core battery at a charge rate of less than about 3 C.

8. The apparatus of claim 5, wherein the electrical load distribution to said at least one high-power, low-energy density storage battery is achieved at a state-of-charge range between about 30% and about 100%.

9. The apparatus of claim 1, wherein said at least one core battery is chosen from lithium-ion batteries, lithium metal batteries, nickel-metal-hydride batteries, sodium-nickel-chloride batteries, and combinations thereof.

10. The apparatus of claim 9, wherein said lithium-ion batteries and said lithium metal batteries comprise solid-state batteries having chemistries chosen from sulfide, polymer, oxide, and combinations thereof.

11. The apparatus of claim 1, wherein said at least one high-power, low-energy density storage battery comprises: a lithium ferrophosphate cathode, a graphite anode, and a thermally stable liquid electrolyte.

12. The apparatus of claim 1, wherein said at least one secondary battery comprises a low nickel concentration, nickel-manganese-cobalt oxide cathode.

13. The apparatus of claim 1, wherein said at least one high-power, low-energy density storage battery is electrically connected in parallel with said at least one core battery and said at least one secondary battery.

14. The apparatus of claim 1, wherein said at least one secondary battery comprises two secondary batteries electrically connected in parallel with each other, and in series with said at least one core battery.

15. The apparatus of claim 1, wherein said at least one core battery is disposed at several locations in said autonomous vehicle.

16. A method for electrochemical energy battery charging and use for an autonomous electric vehicle having regenerative electrical energy capability, comprising:
charging at least one core battery when the autonomous vehicle is idle using a charger external to the autonomous vehicle;
charging at least one intermediate power and energy density secondary battery in series connection with the at least one core battery, using electrical energy from the at least one core battery;
providing propulsion and other electrical requirements of the autonomous vehicle using the at least one secondary battery maintaining the at least one secondary battery at a chosen temperature;
charging at least one high-power, low-energy density storage battery from the regenerative electrical energy capability of the autonomous vehicle;
providing acceleration requirements of the autonomous vehicle using the high-power, low-energy storage battery; and
controlling said steps of battery charging and acceleration, propulsion and other electrical requirements of the autonomous vehicle using a battery controller.

17. The method of claim 16, further comprising the step of controlling the autonomous vehicle using remote drive cycle governance instructions.

18. The method of claim 16, further comprising the step of charging the at least one secondary battery from the regenerative electrical energy capability of said autonomous vehicle in addition to said step of charging the at least one secondary battery using electrical energy from the at least one core battery.

19. The method of claim 16, further comprising the step of controllably distributing electrical load of the autonomous vehicle using the battery controller to the at least one core battery, to the at least one secondary battery, and to the at least one high-power, low-energy density storage battery, whereby both beginning-of-life and end-of-life requirements of the at least one core battery, the at least one secondary battery, and the at least one high-power, low-energy density storage battery are satisfied.

20. The method of claim 16, wherein the at least one core battery is chosen from lithium-ion batteries, lithium metal batteries, nickel-metal-hydride batteries, sodium-nickel-chloride batteries, and combinations thereof.

21. The method of claim 20, wherein the lithium-ion batteries and lithium metal batteries comprise solid-state batteries having chemistries chosen from sulfide, polymer, oxide, and combinations thereof.

22. The method of claim 16, wherein the at least one high-power, low-energy density storage battery comprises: a lithium ferrophosphate cathode, a graphite anode, and a thermally stable liquid electrolyte.

23. The method of claim 16, wherein the at least one secondary battery comprises a low nickel concentration, nickel-manganese-cobalt oxide cathode.

24. The method of claim 16, wherein the at least one high-power, low-energy density storage battery is electrically connected in parallel with the at least one core battery and the at least one secondary battery.

25. The method of claim 16, wherein the at least one secondary battery comprises two secondary batteries electrically connected in parallel with each other, and in series with the at least one core battery.

26. The method of claim 25, wherein the two secondary batteries provide electrical power and electrical energy to the autonomous electrical vehicle by the procedure chosen from (a) both secondary batteries simultaneously providing power and energy; (b) one secondary battery providing power and energy, while the second secondary battery is idle; and (c) one secondary battery providing power, while the second secondary battery is being recharged by the at least one core battery.

27. The method of claim 16, wherein the at least one core battery is disposed at several locations in the autonomous vehicle.

28. An apparatus for electrochemical energy storage for high-power and high-energy applications having regenerative electrical energy capability, comprising:
at least one high-power, low-energy density storage battery for receiving charging from said regenerative electrical energy capability;
at least one high-energy density core battery;
at least one intermediate power and energy density secondary battery in series connection with said at least one core battery for receiving electrical energy from said at least one core battery;
a thermal management system for maintaining said at least one secondary battery at a chosen temperature; and
a battery controller.

29. The apparatus of claim 28, wherein said high-power and high-energy applications comprise high-power and high-energy requirements of an autonomous electric vehicle.

30. The apparatus of claim 28, wherein said autonomous vehicle further comprises a remote drive cycle governor.

31. The apparatus of claim 28, wherein said at least one secondary battery receives charging from said regenerative electrical energy capability in addition to receiving electrical energy from said at least one core battery.

32. The apparatus of claim 28, wherein electrical load for said high-power and high-energy applications is controllably distributed by said battery controller to said at least one core battery, to said at least one secondary battery, and to said at least one high-power, low-energy density storage battery, to satisfy both beginning-of-life and end-of-life requirements of said at least one core battery, said at least one secondary battery, and said at least one high-power, low-energy density storage battery.

33. The apparatus of claim 28, wherein said at least one core battery is chosen from lithium-ion batteries, lithium metal batteries, nickel-metal-hydride batteries, sodium-nickel-chloride batteries, and combinations thereof.

34. The apparatus of claim 28, wherein said lithium-ion batteries and lithium metal batteries comprise solid-state batteries having chemistries chosen from sulfide, polymer, oxide, and combinations thereof.

35. The apparatus of claim 28, wherein said at least one high-power, low-energy density storage battery comprises: a lithium ferrophosphate cathode, a graphite anode, and a thermally stable liquid electrolyte.

36. The apparatus of claim 28, wherein said at least one secondary battery comprises a low nickel concentration, nickel-manganese-cobalt cathode.

37. The apparatus of claim 28, wherein said at least one high-power, low-energy density storage battery is electrically connected in parallel with said at least one core battery and said at least one secondary battery.

38. The apparatus of claim 28, wherein said at least one secondary battery comprises two secondary batteries electrically connected in parallel with each other, and in series with said at least one core battery.
